(19) United States
(12) Patent Application Publication
(10) Pub. No.: US 2011/0093331 A1
(43) Pub. Date: Apr. 21, 2011

(54) Term Weighting for Contextual Advertising

(76) Inventors: Donald Metzler, Santa Clara, CA (US); Andrei Broder, Menlo Park, CA (US); Vanja Josifovski, Los Gatos, CA (US); Kishore Papineni, Carmel, NY (US); Alexander Smola, Santa Clara, CA (US); George Mavromatis, Mountain View, CA (US); Evgeniy Gabrilovich, Sunnyvale, CA (US)

(21) Appl. No.: 12/581,638

(22) Filed: Oct. 19, 2009

(51) Int. Cl. G06Q 30/00

(52) U.S. Cl. 705/14.49

(57) ABSTRACT

A contextual advertising system selects online advertisements for display on a network location. The system may transform page content of a page received in a platform over a network into a textual representation. In addition, the system may transform received site content of a site into a site signature. The site includes the page. The system then may correct the textual representation utilizing the site signature to produce modified textual representation. The system may utilize the modified textual representation to select an online advertisement. Considering a page in the context of the entire website to which it belongs leads to better understanding and interpretation of the page topic(s) and thus yields more accurate ad matching.

### BACKGROUND

1. Field

The information disclosed relates to online advertising. More particularly, the information disclosed relates to displaying advertisements on a webpage based on the content for display to the webpage visitor and the content contained in the website hosting that webpage.

2. Background Information

The marketing of products and services online over the Internet through advertisements is big business. In February 2008, the IAB Internet Advertising Revenue Report conducted by PricewaterhouseCoopers announced that PricewaterhouseCoopers anticipated the Internet advertising revenues for 2007 to exceed US$21 billion. With 2007 revenues increasing 25 percent over the previous 2006 revenue record of nearly US$16.9 billion, Internet advertising presently is experiencing unabated growth.

Unlike print and television advertisement that primarily seeks to reach a target audience, Internet advertising seeks to reach target individuals. The individuals need not be in a particular geographic location and Internet advertisers may elicit responses and receive instant responses from individuals. As a result, Internet advertising is a much more cost effective channel in which to advertise.

Contextual advertising is the task of displaying ads on webpages based on the content displayed to the user. A goal is to display ads that are relevant to the user, in the context of the page, so that the user clicks on the ad thereby generating revenue for the webpage owner and the advertising network. It is desirable to increase the display ad relevance.

### SUMMARY

A contextual advertising system selects online advertisements for display on a network location. The system may transform page content of a page received in a platform over a network into a textual representation. In addition, the system may transform received site content of a site into a site signature. The site includes the page. The system then may correct the textual representation utilizing the site signature to produce modified textual representation. The system may utilize the modified textual representation to select an online advertisement. Considering a page in the context of the entire website to which it belongs leads to better understanding and interpretation of the page topic(s) and thus yields more accurate ad matching.

### BRIEF DESCRIPTION OF THE FIGURES

FIG. 1 is a flow diagram illustrating a method 100 to facilitate real-time processing of site and page content and matching of the site-weight adjusted page content to advertising information.

FIG. 2 is a block diagram illustrating an exemplar/network-based network entity 202 containing a system 200 to facilitate real-time matching of content to advertising information.

FIG. 3 is block diagram illustrating an exemplary interface 300 to display content and associated advertising information for users 230.

FIG. 4 is a block diagram illustrating a system 400 to facilitate real-time matching of content to advertising information within the network-based network entity 202.

FIG. 5 is a block diagram illustrating a data storage module 500 within network-based network entity 202 of system 200.

FIG. 6 is a flow diagram illustrating a method 600 to process page content information 310 received at network-based network entity 202 to construct a page summary.

FIG. 7 depicts an example centroid distribution 700 of words on a website.

FIG. 8 is a flow diagram illustrating a method 800 to process site content information 330 received at network-based network entity 202 to construct a site summary.

FIG. 9 is a graph 900 illustrating the computation of correction factors using the simplified distance-based example.

FIG. 10 is a plot of the NDCG gain for the CM-A data set over the baseline.

FIG. 11 is a plot of the NDCG gain for the CM-B data set over the baseline.

FIG. 12 is a diagrammatic representation of a network 1200.

### DETAILED DESCRIPTION

The following describes system-implemented methods to improve online advertisement matching relevance by taking into account both page level information and site level information. A website may include multiple webpages, some of which have little ad matching context. Advertisements on each webpage need to be relevant to the user's interest to avoid degrading the user's experience and to increase the probability of reaction.

In implementing the below methods, an advertising network may utilize a collective of the multiple webpages to upweight page features such as words and phrases that are related to the site as a whole and to downweight those page features that are unrelated to the site. In this way, the advertising network may expand the ad-matching context from the page to the entire site, which typically is more informative and feature-rich. By using site- or domain-level information to match more contextually relevant ads through improved page term weights, the site-specific term weighting for contextual advertising methods would not only provide page users with a more enriched online experience, but likely result in increased advertisement click-through rates to ultimately increase advertisement revenue for the webpage owner and the advertising network.

In a broader sense, contextual advertising includes a task of displaying ads on webpages under conditions in which the content of the webpages exist or occurs. A goal is to display ads that are relevant to the user, in the context of the page, so that the user clicks on the ad thereby generating revenue for the webpage owner and the advertising network (e.g., Yahoo!™). Here, a key challenge of contextual advertising is identifying ads that are relevant to the content of a given webpage. By not considering a page vocabulary in isolation, the disclosed methods work to avoid undesirable results. For example, a webpage review of the 1987 Danish film “Babette's Feast”™ on a movie-blog website would more likely trigger ads related to art house movies rather than ads about cookware, even though an elaborate dinner at the end of the film is central to the plot. On the other hand, a mention of “Babette's Feast”™ on a webpage for a food blog website would be less likely to trigger ads about renting art house movies since the food topical weighting from the overall website may give the art house movie aspect of the term “Babette's Feast”™ less weight. In general, a word used in an unusual sense on a site should not trigger ads based on the common sense of the word, and ads on low content webpages should reflect the topic of the site rather than the few words on the page.

To address these and other issues, the techniques may analyze the page content in the broader context of the website to which it belongs. The system implementing the methods may represent the page content as a weighted term vector or other textual representation. Simultaneously, the system may capture the website's most prominent terms and their weights in a site signature. The site signature may be the centroid of the set of term vectors associated with its constituent pages. The system then may utilize the site signature to correct the weights of terms in the page term vector. In other words, the system first selects features and determines the correction factors based on the content of the site as a whole, without considering the target page until runtime. The system makes use of the explicit corpus structure, and therefore is likely to provide a more accurate generalized representation of a document than an approach that automatically induces the corpus structure.

In regards to the website as a whole, the discussion details three different methods to compute the positive and negative affinity of webpage terms to the website as a whole. In general, the methods compute the affinity expanding each individual webpage term to a term vector using external knowledge derived from Internet search results for those terms. Where there is similarity between the term vector and the site signature, the methods may boost the weights of those webpage terms that convey the gist of the host website while deemphasizing extraneous or misleading webpage terms. The synergistic effects of the methods leads to consistent and significant improvements in retrieved advertisement quality as confirmed through empirical evaluation with human judged real-life ad data.

In the following description, numerous details are set forth for purpose of explanation. However, one of ordinary skill in the art will realize that a skilled person may practice the methods without the use of the specific details. In other instances, the disclosure may show well-known structures and devices in block diagram form to prevent unnecessary details from obscuring the written description.

In the examples described below, users may access an entity, such as, for example, a content service-provider, over a network such as the Internet and further input various data, which the system subsequently may capture by selective processing modules within the network-based entity. The user input typically comprises “events.” In one example, an event may be a type of action initiated by the user, typically through a conventional mouse click command. Events include, for example, advertisement clicks, search queries, search clicks, sponsored listing clicks, page views, and advertisement views. However, events, as used herein, may include any type of online navigational interaction or search-related events.

Each of such events initiated by a user may trigger a transfer of content information to the user. The user may see the displayed content information typically in the form of a webpage on the user's client computer. The webpage may incorporate content provided by publishers, where the content may include, for example, articles, and/or other data of interest to users displayed in a variety of formats. In addition, the webpage also may incorporate advertisements provided on behalf of various advertisers over the network by an advertising agency, where the advertising agency may be included within the entity, or in an alternative, the system may link the entity, the advertisers, and the advertising agency, for example.

In the examples, the entity may construct in real-time a site summary of the site content displayed within the website and further may analyze additional data related to the website to extract keywords relevant to the site content. Here, the advertising network or other entity may identify a set of words, phrases, and other discriminative features for a set of webpages that make up a site. The entity additionally may construct in real-time a site summary of the page content displayed within the webpage and further may analyze additional data related to the webpage to extract keywords relevant to the page content. In the actual time that it takes a process to occur, the entity subsequently may classify the site content, the page content, and other interesting features into respective content categories of a content database based on the site summary, the page summary, and the associated keywords.

Once the system has identified a set of interesting features, the entity may utilize methods to upweight, downweight, or otherwise correct the page weights for the features. The below describes unsupervised and supervised methods to determine page feature corrections utilizing the site summary to correct the weights given to features in the page summary. In the unsupervised methods, the entity may compute the semantic similarity between a feature and the site. The system may represent features semantically by using web search results and features that are semantically similar to the site are upweighted, whereas those that are not are downweighted. In the supervised machine learning methods, the system automatically may utilize click data and/or human judgments to learn the feature weight corrections that optimize ad relevance. In particular, the entity may use direct optimization strategies as well as stochastic gradient descent over a convex approximation loss function that approximates the true loss.

With the weight of each page feature corrected, the entity may select the advertisements for display within the webpage by contextually matching advertisements and the weighted webpage content information provided by the publishers. Other classifications of webpages and advertisements may be utilized with the disclosed methods, such as additional parameters applied by the entity and classifications based on user interests, as determined by a behavioral targeting system, for example.

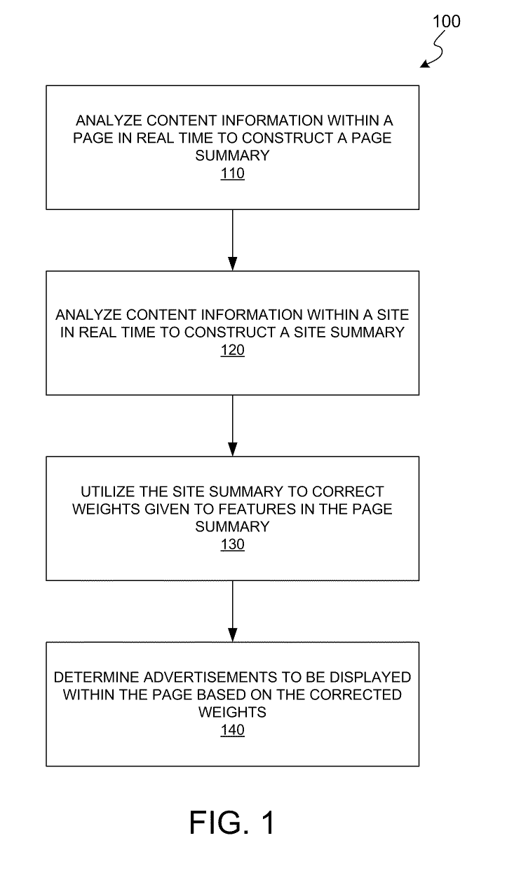

FIG. 1 is a flow diagram illustrating a method 100 to facilitate real-time processing of site and page content and matching of the site-weight adjusted page content to advertising information. Method 100 may start at processing block 110 and implement real-time analysis of the content information within the actual webpage requested by the user to construct a site summary of the page content information. At processing block 120, method 100 may engage in real-time analysis of the content information within a website containing the webpage requested by a user to construct a site summary of the site content information. Method 100 may perform processing block 110 and processing block 120 simultaneously or in a different order.

In one example, users or agents of the users access a publisher over a network and request a webpage populated with content information. Generally, the system may present the content information to the user in a variety of formats, such as, for example, text, images, video, audio, animation, program code, data structures, hyperlinks, and other formats. The content may be typically presented as a webpage and may be formatted according to the Hypertext Markup Language (HTML), the Extensible Markup Language (XML), the Standard Generalized Markup Language (SGML), or any other known language.

In response to the request for a webpage populated with content information, the publisher may transmit the requested webpage content information to the user for display on the user's machine. At or about the same time, the system may transmit a JavaScript call routine or a Hypertext Transfer Protocol (HTTP) call routine to the entity to request advertisements for insertion into the webpage. This may occur while the user's machine prepares to display the webpage. The call routine may reside in or be embedded onto the webpage. The insertion may be via an iframe mechanism, or JavaScript, or any other known embedding mechanism. In one example, the request for advertisements contains the Uniform Resource Locator (URL) of the webpage and additional data related to the webpage.

In an alternate example, upon receipt of the webpage request, the publisher may access the entity to request advertisements for insertion into the webpage prior to display of the webpage on the client machine associated with the user. The entity may receive the advertising request and the webpage information and analyzes the site and page content in real-time to construct a site summary and a page summary, respectively. The entity may assign initial or preliminary weights to the features in the page summary as an initial importance of each feature.

At processing block 130, method 100 may utilize the site summary to correct weights given to features in the page summary. For example, the site www.airliners.net generally is devoted to photographs of airliners. If a page contains the phrase “airline photos,” method 100 may increase the weight of the phrase “airline photos” because the site as a whole is about this concept, namely photographs of airliners. However, generic, yet prevalent terms on the requested webpage such as “privacy” or “forum” may be downweighted because of the terms lack of relatedness to the www.airliners.net site. Often, a requested webpage may contain little ad matching content and method 100 may utilize the more informative and feature-rich aspects of the entire website to expand the ad matching context of the webpage to the entire website.

Finally, at processing block 140, the sequence may continue with the entity determining the particular advertising information for display within the webpage requested by the user based on the constructed site summary, the constructed page summary, and extracted associated keywords. As used herein, in one example, advertising information may be sent to the user that requests the webpage and includes multiple advertisements, which may include a hyperlink, such as, for example, a sponsor link, an integrated link, an inside link, or other known link. The format of an advertisement may or may not be similar to the format of the content displayed on the webpage and may include, for example, text advertisements, graphics advertisements, rich media advertisements, and other known types of advertisements. Alternatively, method 100 may transmit the advertisements to the publisher, which may assemble the webpage content and the advertisements for display on the client machine coupled to the user.

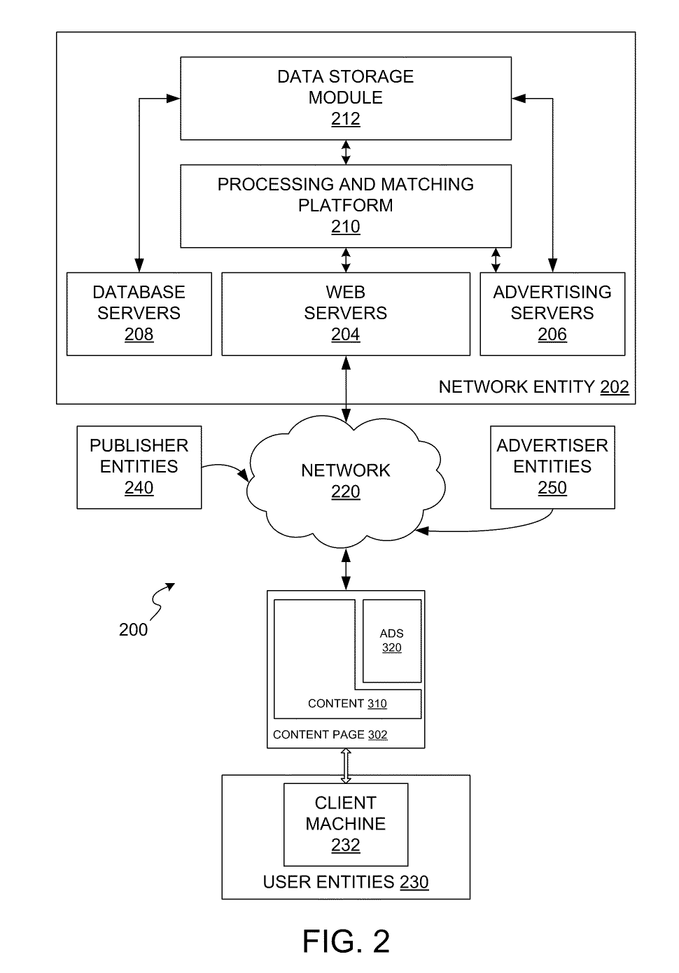

FIG. 2 is a block diagram illustrating an exemplar/network-based network entity 202 containing a system 200 to facilitate real-time matching of content to advertising information. The description conveys system 200 within the context of network entity 202 enabling automatic real-time matching of webpage content to advertising information. However, it will be appreciated by those skilled in the art that the methods will find application in many different types of computer-based, and network-based, entities, such as, for example, commerce entities, content provider entities, or other known entities having a presence on the network.

In one example, network entity 202 may be a network content service provider, such as, for example, Yahoo!™ and its associated properties. Network entity 202 may include front-end web processing servers 204, which may, for example, deliver webpages 302 and other markup language documents to multiple users, and/or handle search requests to network entity 202. Web servers 204 may provide automated communications to/between users of network entity 202. Display may include a presentation to communicate particular information. In addition, web servers 204 may deliver images for display within webpages 302, and/or deliver content information to the users in various formats.

Network entity 202 further may include processing servers to provide an intelligent interface to the back-end of network entity 202. For example, network entity 202 further may include back-end servers, for example, advertising servers 206, and database servers 208. Each server may maintain and facilitate access to data storage modules 212. In one example, advertising servers 206 may be coupled to data storage module 212 and may transmit and receive advertising content, such as, for example, advertisements, sponsored links, integrated links, and other known types of advertising content, to/from advertiser entities via network 220. In one example, network entity 202 further may include a system to facilitate real-time matching of content to advertising information within network-based network entity 202.

The system further may include a processing and matching platform 210 coupled to data storage module 212. The system may connect platform 210 and web servers 204. In addition, the system may connect platform 210 to advertising servers 206.

Client programs may access network-based network entity 202. Client programs may include an application or system that accesses a remote service on another computer system, known as a server, by way of a network. These client programs may include a browser such as the Internet Explore™ browser distributed by Microsoft Corporation of Redmond, Wash., Netscape's Navigator™ browser, the Mozilla™ browser, a wireless application protocol enabled browser in the case of a cellular phone, a PDA, or other wireless device. Preferably, the browser may execute on a client machine 232 of a user entity 230 and may access network entity 202 to receive a content page 302 via a network 220, such as, for example, the Internet. Content page 302 may be an example network location. Other examples of networks that a client may utilize to access network entity 202 may include a wide area network (WAN), a local area network (LAN), a wireless network (e.g., a cellular network), a virtual private network (VPN), the Plain Old Telephone Service (POTS) network, or other known networks.

Other entitles such as, for example, publisher entitles 240 and advertiser entities 250, may access network-based network entity 202 through network 220. Publisher entities 240 may communicate with both web servers 204 and user entitles 230 to populate webpages 302 with appropriate content information 310 and to display webpages 302 for users 230 on their respective client machines 232. Publishers 240 may be the owners of webpages 302, and each webpage 302 may receive and display advertisements 320. Publishers 240 typically may aim to maximize advertising revenue while providing a positive user experience. Publisher entities 240 may include website that has inventory to receive delivery of advertisements, including messages and communication forms used to help sell products and services. The publisher's website may display a website may have webpages and advertisements. Visitors or users 230 may include those individuals that access webpages through use of a browser.

Advertiser entities 250 may communicate with web servers 204 and advertising servers 206 to transmit advertisements for display as ads 320 in those webpages 302 requested by users 230. Online advertisements may be communication devices used to help sell products and services through network 220. Advertiser entities 250 may supply the ads in specific temporal and thematic campaigns and typically try to promote products and services during those campaigns.

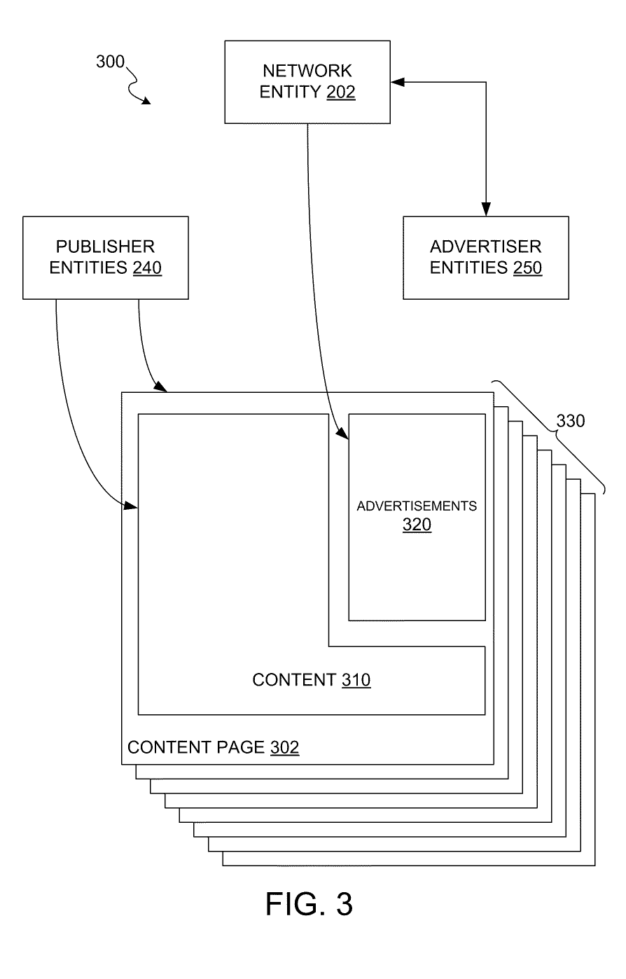

In regards to online marketing, contextual advertising involves four primary entities. Publishers 240 may own webpages 330 (FIG. 3) and may rent a small portion of a webpage 302 to advertisers 250. Advertisers 250 may supply advertisements, with goal of promoting products or services. Users 230 may visit webpage 302 interact with ads 320. Finally, ad network 202 may have a role in selecting the ads 320 for the given user 230 visiting a page 302.

Content 310 may include text, images, and other communicative devices. Content 310 may be separate from the structural design of webpage 302 or website 330, which may provide a framework into which content 310 may be inserted, and separate from the presentation of webpage 302 or website 330, which involves graphic design. A Content Management System may change and update content, rather than the structural or graphic design of webpage 302 or website 330.

A goal of a contextual advertising system 200 may be to place ads 320 related to content 310 of page 302 to provide a good experience for user 230. In turn, this good user experience may increase a likelihood that user 230 will click on one or more of the ads 320. Previous research into topical advertising has confirmed that displaying ads that are more relevant results in more ad clicks.

Advertisers 250 annotate their contextual advertisements with one or more bid phrases, owing to the system used for sponsored search advertising. However, the bid phrase typically has no direct bearing on the ad placement in contextual advertising. Instead, the bid phrase may provide a concise description of the target ad audience, as determined by the advertiser. For this reason, the bid phrase may be an important feature for successful ad placement. In addition to the bid phrase, the displayed few lines of text included with a short title and a creative further may characterize advertisements. The industry typically refers to advertised webpage as the landing page and each advertisement may contain the URL of the landing page. The network location in the Uniform Resource Locator (URL) may be a unique name that identifies an Internet server. A URL network location may include two or more parts, separated by periods, and users entities 230 may refer to a URL network location as the host name and Internet address.

FIG. 3 is block diagram illustrating an exemplary interface 300 to display content and associated advertising information for users 230. Interface 300 may include content page 302, such as, for example, a webpage requested by user 230 or an agent of the user. Content page 302 may incorporate content information provided by publishers 240 and displayed in a content area 310. In one example, content may include published information, such as, for example, articles, and/or other data of interest to users, often displayed in a variety of formats, such as text, video, audio, hyperlinks, or other known formats.

Webpage 302 further may incorporate advertisements provided by advertiser entities 250 via network entity 202 or, in the alternative, an advertising agency (not shown), which may be included within network entity 202, or in the alternative, may be coupled to network entity 202 and the advertiser entities 250, for example. In another alternate example, the system may transmit the advertisements to publishers 240 for subsequent transmission to users 230. Content page 302 may display the advertisements in an advertisements area 320. Webpage 302 may be composed and then displayed within the client browser running on client machine 232 associated with user 230.

Publisher entity 240 may manage a website 330. Website 330 may be a collection of related digital assets addressed with a common domain name or Internet Protocol (IP) address in an Internet Protocol-based network. Site 330 may be the set of pages that form an entire web domain, where a web domain may include a Domain Name System (DNS) identification label that defines a realm of administrative autonomy, authority, and/or control in network 220. At least one web server accessible through network 220 may host website 330.

As noted above, website 330 may have webpages. For any given client machine 232, advertisements may be displayed on only those webpages visible on the monitor of user 230. While the content of each webpage may be predetermined, the displayed advertisements themselves typically are determined in real time. Here, the system still may consider the content of each webpage as part of website 330 even if not displayed at a given moment.

Website 330 (or domain 330) may include words, phrases, and other discriminative features. These features may be characterized by the number of times or frequency in which the feature appears in website 330. In addition, the system may characterize the features by the average ‘aboutness’ of the feature with respect to website 330 through a site-level average term frequency-inverse document frequency (TF.IDF). Once the system has identified a set of interesting features, the system may utilize methods to upweight correct or downweight correct the page weights for the features.

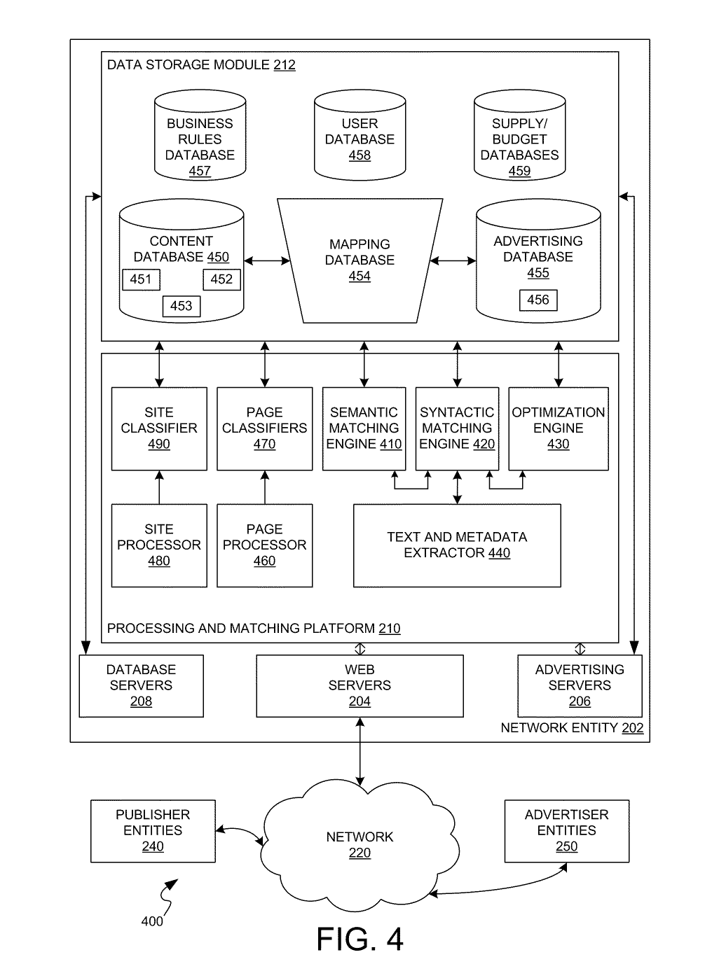

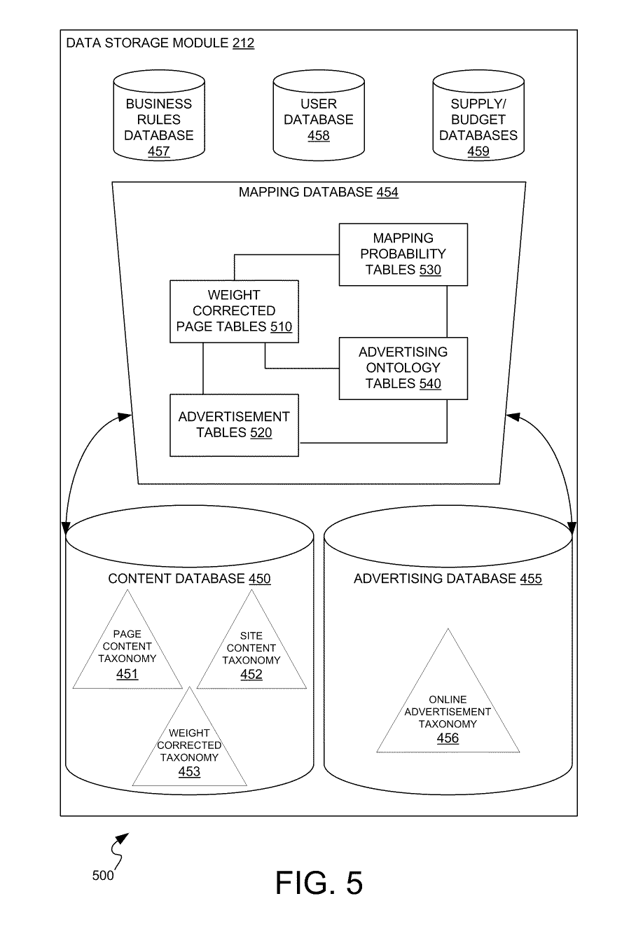

FIG. 4 is a block diagram illustrating a system 400 to facilitate real-time matching of content to advertising information within the network-based network entity 202. System 400 include processing and matching platform 210 coupled to multiple databases within the data storage module 212 such as, for example, a content database 450 having a page content taxonomy 451, a site content taxonomy 452, and a weight corrected page content taxonomy 453, and include a mapping database 454, and an advertising database 455. Mapping database 454 may be coupled between content database 450 and advertising database 455. Advertising database 455 may include an online advertisement taxonomy 456. Here, the advertising database 455 may include a plurality of advertisements and associated advertising content information. System 200 may classify each advertisement according to themes to characterize a general subject matter of each advertisement. In a further example, mapping database 454 may store a mapping matrix, which may include links between weight corrected page content taxonomy 453 stored within content database 450 and corresponding advertisements 456 stored within advertising database 455 in connection with FIG. 5.

Data storage module 212 further may include other databases, such as, for example, a business rules database 457, a user database 458, supply/budget databases 459. Processing and matching platform 210 within the system 400 enables matching of the page content to related advertisements based on data stored in the associated databases 450 through 459. System 200 may implement each database within the data storage module 212 as a relational database. In another example, system 200 may implement each database within the data storage module 212 as a collection of objects in an object-oriented database.

Platform 210 may include a semantic matching engine 410, a syntactic matching engine 420, an optimization engine 430, and a text and metadata extractor 440. Semantic matching engine 410, syntactic matching engine 420, and optimization engine 430 each may be connected to data storage module 212, and syntactic matching engine 420 may be connected between semantic matching engine 410, optimization engine 430, and text and metadata extractor 440.

Semantic matching engine 410 may be a hardware and/or software module configured to determine which advertisements classified in respective advertising categories are related to themes of the webpage requested by user entity 230 from publisher 240, such as, for example, general subject matters contextually related to content presented on webpage 302.

Syntactic matching engine 420 may be a hardware and/or software module configured to select advertisements that closely match the extracted keywords and metadata and further match a set of predetermined parameters retrieved from respective databases, such as, for example, business rules database 457, user database 458, and/or supply/budget databases 459. Optimization engine 430 may be a hardware and/or software module configured to filter and select specific advertisements for display to the user based on feedback data related to prior associations between webpages and corresponding displayed advertisements. Text and metadata extractor 440 may be at least one of a hardware module and a software module configured to extract keywords and associated metadata from webpages, and a syntactic matching engine 420 coupled to the text and metadata extractor 440.

Platform 210 additionally may include a page processor 460 coupled to a page classifier 470 and a site processor 480 coupled to a site classifier 490. System 200 may couple page processor 460 and site processor 480 to respective databases 450 through 459 within the data storage module 212.

Page processor 460 may be a hardware and/or software module configured to analyze in real-time content information within webpage 302 to construct page summaries highly informative of the entire page content. Page processor 460 further analyzes data associated webpage 302 such as, for example, the page URL and the referrer URL, to extract keywords relevant to the page content. Page classifier 470 may be at least one of a hardware module and a software module configured to classify webpage 302 and its associated content information into respective categories of page content taxonomy 451 to increase the page representation for subsequent advertisement matching.

Site processor 480 may be a hardware and/or software module configured to analyze in real-time content information within website 330 to construct site summaries highly informative of the entire site content. Site processor 480 further analyzes data associated website 330 such as, for example, the site URL, to extract keywords relevant to the site content. Site classifier 490 may be a hardware and/or software module configured to classify website 330 and its associated content information into respective categories of site content taxonomy 452.

FIG. 5 is a block diagram illustrating a data storage module 500 within network-based network entity 202 of system 200. System 200 further may organize webpage 302, website 330, and associated content information into hierarchical content taxonomies within content database 450. The hierarchical content taxonomies may include page content taxonomy 451, site content taxonomy 452, and weight corrected page content taxonomy 453 and may be an arrangement of the contents into groups according to the relationship of each to the others. System 200 may base this organization on associations with their respective events of origin and based on various page parameters, such as, for example, page ancestors, anchor text metadata, publisher entity 240 associated with each respective webpage, and other features of the webpages. System 200 review, edit, and automatically update each hierarchical content taxonomy through processing and matching platform 210, or, in the alternative, manually by editors and/or other third-party entities.

The advertisements further may be organized into an online advertising taxonomy 520 arranged hierarchically within advertising database 455. This arrangement may be based on various advertisement parameters, such as, for example, text of each advertisement offer, advertiser entity 250 associated with each respective advertisement, advertiser industry, target page of each specific advertisement, and other features of the stored advertisements. System 200 review, edit, and automatically update hierarchical online advertising taxonomy 456 through processing and matching platform 210, or, in the alternative, manually by editors and/or other third-party entities.

System 200 may represent each content taxonomy, including page content taxonomy 451, site content taxonomy 452, and weight corrected page content taxonomy 453, and online advertising taxonomy 456, as hierarchies of nodes. However, a skilled person utilized other representation of a taxonomy to classify subject matter in conjunction with system 400 and data storage module 500 without deviating from the spirit or scope of the disclosed subject matter. The matching process may require that the taxonomies provide sufficient differentiation between the common commercial topics.

Classifying all medical related pages into one node may not result into a good classification since both “sore foot” and “flu” pages may end up in the same node. However, the advertisements suitable for these two concepts may be very different. As a result, system 200 may utilize a taxonomy of around 6000 nodes to obtain sufficient resolution and to classify webpage 302, website 330, and advertisements 320 within the respective taxonomies 451, 452, 453, and 456. System 200 may build the nodes primarily to classify commercial interest queries, rather than pages or ads.

System 200 may utilize other taxonomies in conjunction with system 400. System 200 may represent each node in the exemplary taxonomy described above as a collection of exemplary bid phrases or queries that correspond to that node concept. In one example, each node has on average around 100 queries. Queries placed in the taxonomy may be high volume queries and queries of high interest to advertiser entities 250. System 200 may recognize high volume queries and queries of high interest to advertiser entities 250 through an unusually high cost-per-click (CPC) price. System 200 may receive human input and human editors using keyword suggestion tools similar to the ones utilized by advertising agencies may populate the taxonomy. For example, network entity 202 or an agency coupled to network entity 202 may suggest keywords to advertiser entities 250.

Mapping database 454 (FIG. 5) may store webpage information, advertisement information, and associations between the stored webpage information and the advertisement information. For example, mapping database 454 may store probability scores indicating that certain advertisements match themes of a respective webpage and logical associations between advertisement information and webpage information. Implemented may include something developed and/or put into place. System 200 may implement mapping database 454 as a relational database, and may include a number of tables having entries, or records, that may be linked by indices and keys. In an alternative example, system 200 may implement mapping database 454 as a collection of objects in an object-oriented database.

Mapping database 454 may include weight corrected page tables 510, advertisement tables 520, mapping probability tables 530, and advertising ontology tables 540. System 200 may connect weight corrected page tables 510 and advertising ontology tables 540 in parallel between both advertisement tables 520 and mapping probability tables 530. Moreover, system 200 may connect weight corrected page tables 510 and advertising ontology tables 540 to each other.

Weight corrected page tables 510 may be central to mapping database 454 and may contain records for each webpage 302 stored within weight corrected page content taxonomy 453. System 200 may link advertisement tables 520 to weight corrected page tables 510 and may populate advertisement tables 520 with records for each advertisement stored within online advertising taxonomy 456. Mapping probability tables 530 may store multiple probability scores, each score indicating a probability that a certain type of advertisement stored within online advertising taxonomy 456 matches the themes of a respective webpage stored within weight corrected page tables 510. Advertising ontology tables 540 may store logical associations between advertisements stored within online advertising taxonomy 456 and content of the webpages stored within weight corrected page content taxonomy 453.

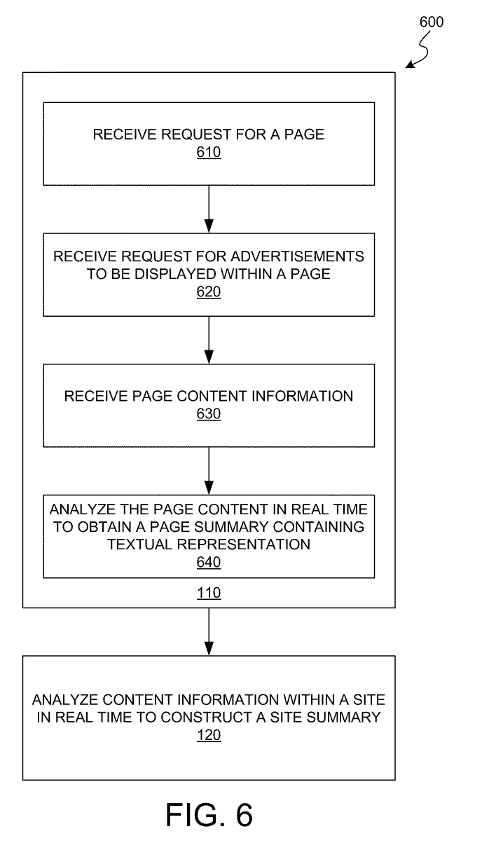

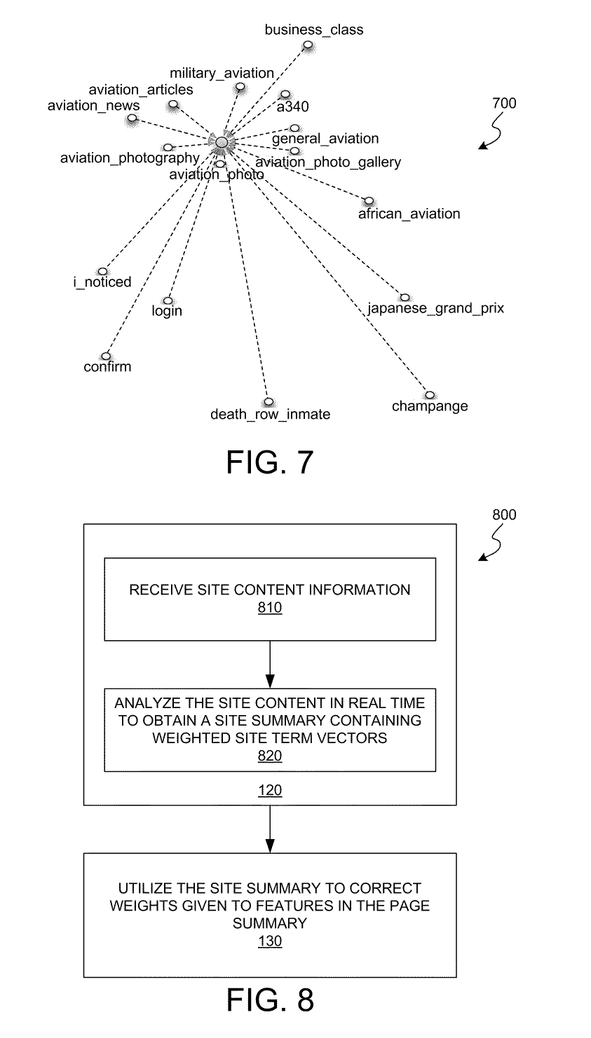

FIG. 6 is a flow diagram illustrating a method 600 to process page content information 310 received at network-based network entity 202 to construct a page summary. A term may include a word or a phrase and system 200 may represent each term within content 310 a page term vector. As discussed in more detail in connection with FIG. 7 and FIG. 8 below, system 200 may represent website 330 as a site term vector so that system 200 may utilize a cosine metric to assess the degree to which the a give page term vector and the site term vector are similar.

The similarity between these expansions and the site signature may allow system 200 to use multiplicative correction factors to boost the weights of terms that convey the gist of the host website while deemphasizing extraneous or misleading terms. For instance, on a page P from a blog about small business management, system 200 might extract the phrases “small business taxes” and “small business expense management.” System 200 then may issue these two phrases as web queries to return results with webpages related to business management and taxation. By expanding the two phrases into returned webpages, system 200 may determine that their expansion likely is similar to the site signature of the source blog. In turn, system 200 may increase the weight in the term vector associated with the page P. The increased weight in the term vector likely will match more topically relevant ads.

In contrast, “Mercury” on the site of the “San Jose Mercury”™ newspaper should not trigger ads about Mercury cars, even though the most common interpretation of “Mercury” on the Web is as a car make. Here, entering the term “mercury” in a search engine may result in pages about the planet Mercury, Mercury™ cars, mercury mining, and many other mercury pages unrelated to news and the San Jose, Calif. area. As a result, system 300 may determine that there is little similarity between the expansion of the term “mercury” and the signature of San Jose Mercury News™ web site. Accordingly, system 200 may reduce the weight of the term “mercury” on every page where it appears on the San Jose Mercury™ site. Such a computer based outcome makes sense since using “mercury” in online advertisement selection would result in ads that cover the commercial aspects of the above topics, the dominant of which may be car sales.

At processing block 610 in FIG. 6, at least one of network entity 202 and publisher entities 240 may receive a request for content page 302. Here, a person surfing the web may have clicked on a link to transmit a signal to a web content provider to provide the webpage identified by the link. In other words, a browser residing in client machine 232 of user entity 230 may generate a request for a webpage.

At processing block 620, network entity 202 may receive a request to display advertisements 320 within the requested webpage. Advertisements 320 may aid in paying the cost to create and maintain webpage 302. For example, system 200 may transmit through network 220 a JavaScript code request embedded into the webpage to web servers 204 within network entity 202. Alternatively, a server may load the JavaScript code after a display device of client machine 232 displays the requested webpage. The time between processing block 610 and processing block 620 may be milliseconds such that a difference between when content 310 becomes visible to user entity 230 and when ads 320 become visible to user entity 230 may be negligible.

At processing block 630, network entity 202 may receive webpage 302 and its associated page content information 310. Network entity 202 may receive additional data related to the webpage at processing block 630, such as, for example, the webpage URL and the referrer URL. In one example, system 200 may send webpage content information 310 of processing block 630 along with the request for advertisements transmitted by user entities 230 in processing block 620. Network entity 202 may receive webpage 302 and/or its associated page content information 310 over network 220 from at least one of user entities 230, publisher entities 240, and other entities connected to network 220. Network entity 202 may transmit the received information from web servers 204 to processing and matching platform 210.

At processing block 640, system 200 may analyze the individual words, phrases, and other content 310 of content page 302 in real-time to construct a page summary. For example, page processor 460 within processing and matching platform 210 may receive webpage content information 310 and utilize page summarization techniques to analyze that content information to construct a page summary. System 200 may represent the page summary for content page 302 as a set of weighted page term vectors or other textual representation.

Webpages vary from one page to another and the page content of content page 302 may include any communicative content subject to analysis, including images. A textual representation of the page content of content page 302 may include attributes that distinguish such content as an object of study in the form of a tangible rendering of that communicative content. A weighed page term vector may be an example textual representation.

A weighed page term vector may be a textual representation that includes a page term and a vector. A page term may include one or more features of content 310 that may convey a grammatical constituent of a sentence. The features may be a word, a phrase, or other items such as an image or part of an image. When a group of words functions as a single unit in the syntax of a sentence, system 200 may view the page term as a phrase. A vector may be a straight-line segment whose length is magnitude and whose orientation in space is direction, where the magnitude and/or direction may represent a numerical value that may convey a relative importance or weight granted to something the vector.

To represent a meaning of each single page term (e.g., a word or a phrase) of content 310 as a weighted page term vector, system 200 first may submit individual terms as queries to web search engine and retrieved N=40 top search results. In other words, system 200 may crawl the contents of URLs returned by the search engine as part of a blind relevance feedback approach. Here, system 200 may expand each individual term to a term vector using external knowledge derived from web search results. System 200 then may perform feature selection and kept the top M_{w}=50 most salient words and Mₚₕ=50 most salient phrases using a document frequency (DF) feature selection metric. System 200 may represent each page term of content 310 utilizing a weighed page term vector of up to 100 words and phrases, where EV(t) may represent the expansion vector (EV) of term t.

Blind relevance feedback approach and expand term representations using Web search results may be described in detail, for example, in “Optimizing relevance and revenue in ad search: A query substitution approach.” by F. Radlinski et al., in SIGIR'08, 2008, and in “Query enrichment for web-query classification.” by D. Shen et al. ACM TOIS, 24:320-352, 2006, which may be incorporated by reference herein in their entirety. As an example, a system passed the terms “American Airlines”™, “LAX,” and “Lufthansa”™ through a search engine. For “American Airlines”™, the search engine returned Airline, American, flight, ticket, and frequent flyer as the five top-scoring expansion features of “American Airlines”™. For LAX, the search engine returned as the five top-scoring expansion features Los Angeles International Airport, Los Angeles, Tom Bradley International Terminal, hotel, and airport parking. The term “Lufthansa”™ brought back the five terms airline, Lufthansa™ cargo, Star Alliance™, fight, and business class. From processing block 640, method 600 may proceed to processing block 120 (FIG. 1) to engage in real-time analysis of the content information within a website containing the webpage requested by a user to construct a site summary of the site content information.

With a set of weighted page term vectors representing content page 302, a vector also may represent site 330 to aid in quantifying the relatedness of a page term and website 330 through the cosine metric. In particular, a site signature of website 330 may be represented by the centroid of the individual pages that comprise website 330, including webpage 302.

As a motivating example, consider an aviation photography website. A typical page for the aviation photography website may contain a wide range of words, some perfectly related to the site theme and others completely unrelated. The given page also may contain generic words such as “login” or “privacy policy” that are not truly characteristic of the website topic. Matching ads using loosely related or unrelated words is likely to be sub-optimal.

FIG. 7 depicts an example centroid distribution 700 of words on a website. Distribution 700 utilizes vectors to convey the relatedness of the terms to the website. Some words notably are more related to the website topic than others are. Here, distribution 700 shows stronger relationship between individual words and the site through word vectors having shorter distances.

Looking at FIG. 7, there are several ways to incorporate site information into this representation. One way to do so is to perform “page expansion” by adding as features additional terms that the system finds on other pages of the site but not on the current one. However, this approach might be less useful for entire webpages, which are often sufficiently long. Here, a feature vector of the centroid of the individual pages that comprise website 330 may represent a site signature of website 330.

FIG. 8 is a flow diagram illustrating a method 800 to process site content information 330 received at network-based network entity 202 to construct a site summary. Here, system 200 may represent website 330 as a site term vector so that system 200 may utilize a cosine metric to assess the degree to which a given page term vector and the site term vector are similar.

At processing block 810, network entity 202 may receive website 330 and its associated site content information. Network entity 202 may receive additional data related to the website at processing block 810, such as, for example, each webpage URL for the website and each referrer URL. In one example, system 200 may send the website content information of processing block 810 along with webpage 302 and its associated page content information 310 in processing block 630. Network entity 202 may receive website 330 and/or its associated site content information 310 over network 220 from at least one of user entities 230, publisher entities 240, and other entities connected to network 220. Network entity 202 may transmit the received information from web servers 204 to processing and matching platform 210.

At processing block 820, system 200 may analyze the individual words, phrases, and other content of website 330 in real-time to construct a site summary. For example, site processor 480 within processing and matching platform 210 may receive website content information and utilize site summarization techniques to analyze that content information to construct a site summary. System 200 may represent the site summary for content site 302 as a site signature that may be the centroid of the individual pages on the site.

Having represented both the site and terms as feature vectors, system 200 may return from processing block 820 to processing block 130 of FIG. 1 to quantify the relatedness of each term to the entire site and compute the site-specific correction factors for each term. System 200 then may utilize these correction factors to modify term weights in the vectors of individual pages on that site. In implementing multiplicative correction, system 200 may multiply the original term weights in the page vector by the correction factors, and then normalize the resultant vector.

System 200 may divide the computation of correction factors into a term ordering phase and a term weighting phase. In the first phase, system 200 identifies terms for which system 200 will compute correction factors and arranges those identified terms in decreasing order of relatedness to the site. In the second phase, system 200 may compute correction factors for each term. Decoupling these two phases allows system 200 to apply various non-parametric rank-based ordering schemes and makes the entire approach more flexible.

To reduce the amount of computation, system 200 may compute correction factors for the top K=1000 terms that may be most likely to have high impact on the ad selection. In experiments, the inventors explored two different ways of selecting the K terms, namely, site-specific versions of document frequency (DF) or tf.idf scores. The latter method exhibited slightly better performance on a held-out validation set. These experiments showed that tf.idf works better as a term selection metric in this context. A reason for this may be that tf.idf selects features that may be more likely to affect the ad selection. In other words, tf.idf selects features that have higher impact in the cosine similarity. Once system 200 modifies a page vector to boost some terms and de-boost others, ad matching may proceed as described, and system 200 may execute the modified vector as a query against an inverted index of ads. Selecting the ads amounts to computing the cosine of the page and ad vectors, and the system may implement this operation efficiently in the inverted ad index.

The below description details three different examples to compute the positive and negative affinity of page terms to the website as a whole: the distance-based example, the simplified distance-based example, and the rank-based example. Although the below description sets out three example examples of contextual advertising to compute site-specific correction factors as part of selecting online advertisements for display on website, a skilled person would not limit the site-specific correction factor computation factor to any individual example but extend the disclosed examples to cover other examples.

Distance-Based Example

As noted above, processing block 130 of method 100 may utilize the site summary to correct weights given to features in the page summary. In the distance-based example implementing processing block 130, system 200 may utilize a site-based tf.idf weight metric. The tf.idf (term frequency—inverse document frequency) metric is a statistical measure that system 200 may utilize through method 100 to evaluate the aboutness of a term is to the site that hosts that term. In other words, method 100 may utilize tf.idf for the entire site to determine how important a term is to the site that hosts that term.

To correct the weighted page term vectors utilizing the site signature to produce a modified textual representation such as modified page term vectors, the site-level aboutness Ŵ(t, S) may be determine for each term t in website content 310 according to equation (1):

Ŵ(t, S)=cos(EV(t), V(S))·tf(t, S)·sidf(t, S) (1)

where
t Represents a term in website content 310,
S Represents website 330 as the centroid of site S,
Ŵ(t, S) Is the site-level aboutness,
EV(t) Is the expansion vector (EV) of term t (such as computed using web search results)
V(S) Is the vector representation of the centroid of site S (such as computed over individual page vectors),
cos(EV(t), V(S)) Is the cosine between the expanded representation of term t and the site vector that may convey semantic similarity between the feature t and the site s,
tf(t, S) Is the term frequency as a function of the number of times that term t occurs within the site S, and
sidf(t, S) Is the site-level inverse document frequency of the term t, with sidf(t, S) defined as

$$sidf ( t , S ) = log ( 1 + \frac{N ( S )}{N ( t , S )} ) \qquad ( 2 )$$

where
N(t, S) Is the number of pages within site S that contain term t,
N(S) Is the total number of pages on site S.
   Importantly, the unsupervised information retrieval (IR) approach of equation (1) takes into account both how semantically related term t is to the site S via cos(EV(t), V(S)), as well as how prominent the term t is on the site S as a whole via tf.idf.

System 200 may utilize a correction factor to upweight/boost some terms and downweight/dampen others. To utilize the site-level aboutness Ŵ(t, S) directly as a correction factor, it may be important to normalize each correction factor by the average correction factor for the site. Experiments have shown that most values of the site-level aboutness Ŵ(t, S) are greater than one. Here, system 200 may scale the site-level aboutness Ŵ(t, S) of equation (1) according to equation (3):

$$w ( t , S ) = \frac{\hat{w} ( t , S )}{\frac{1}{\vert T ( S ) \vert} {\sum }_{t ∈ T ( s )}^{ } \hat{w} ( t , S )} \qquad ( 3 )$$

where
t Represents a term in website content 310,
S Represents website 330 as the centroid of site S,
w(t, S) Is the scaled site-level aboutness,
Ŵ(t, S) Is the site-level aboutness, and
T(S) Is the set of terms for which system 200 computes the correction factors on site S.

With equation (3) scaling the correction factors, each correction factor is normalized by the average correction factor for the site. In this way, for example, a term that has an average site-level aboutness Ŵ(t, S) will have a correction factor w(t, S) of one through application of equation (3). System 200 may utilize more-complex scaling schemes as well.

In experimentation, system 200 applied the distance-based example implementing processing block 130 to the above-noted aviation photography site. Table 1 below presents a list that includes (i) ten terms having the largest correction factors for the aviation photography site and (ii) ten terms having the smallest correction factors for the aviation photography site:

TABLE 1

| Term | | Correction | Correction |
|---|---|---|---|
| Rank | Term | Factor | to apply |
| 1 | airline | 9.9362 | Upweight |
| 2 | aviation | 9.5907 | Upweight |
| 3 | aviation photo gallery | 5.2225 | Upweight |
| 4 | b737 | 4.7225 | Upweight |
| 5 | b777 | 4.6934 | Upweight |
| 6 | aviation forum | 4.5110 | Upweight |
| 7 | classic airliners | 4.1583 | Upweight |
| 8 | thomsonflyTM | 4.1568 | Upweight |
| 9 | aviation forums | 4.0889 | Upweight |
| 10 | a340 | 3.9269 | Upweight |

. . .

| | | | |
|---|---|---|---|
| 991 | photos forums | 0.0106 | Downweight |
| 992 | find | 0.0105 | Downweight |
| 993 | instant | 0.0103 | Downweight |
| 994 | respond | 0.0095 | Downweight |
| 995 | united states | 0.0092 | Downweight |
| 996 | site | 0.0085 | Downweight |
| 997 | demand media | 0.0082 | Downweight |
| 998 | msg | 0.0057 | Downweight |
| 999 | content | 0.0037 | Downweight |
| 1000 | computer uses | 0.0034 | Downweight |

As in Table 1, the terms with the largest correction factors are those that are highly topically relevant to the aviation photography site. These include general aviation terms such as “airline” and “aviation,” as well as specific terms such as model number of airplane (e.g., “B737” for Boeing™ 737, “B777” for Boeing™ 777, and “A340” for Airbus™ A340) or names of specific airlines (“ThomsonFly”). On the other hand, terms that system 200 deemphasized include words that are overly general, such as “find,” “respond,” and “content.” Other terms that system 200 significantly downweighted or dampened were those that are somewhat topically relevant, but are overly specific, such as “photos forum” and “demand media.”

### Simplified Distance-Based Example

As noted above, processing block 130 of method 100 may utilize the site summary to correct weights given to features in the page summary. In the simplified distance-based example implementing processing block 130, system 200 may take into account how semantically related term t is to the site S via cos(EV(t), V(S)) without taking into account how prominent the term t is on the site S as a whole via tf.idf. That is, the correction factors computed by this method only reflect the relatedness of a term to the site without considering the salience of the term on the site. In addition, system 200 does not compute the correction factors in the simplified distance-based example for all the terms as in the distance-based example. Rather, system 200 computes the correction factors in the simplified distance-based example only for those terms most and least related to the site.

To correct the weighted page term vectors utilizing the site signature to produce a modified textual representation such as modified page term vectors, the simplified site-level aboutness Ŵ_{simplified}(t, S) may be determine for those terms t of website content 310 most and least related to website 333 according to equation (4):

Ŵ_{simplified}(t, S)=cos(EV(t), V(S)) (4)

where
t Represents a term in website content 310,
S Represents website 330 as the centroid of site S
Ŵ_{simplified}(t, S) Is the simplified site-level aboutness,
EV(t) Is the expansion vector (EV) of term t (such as computed using web search results)
V(S) Is the vector representation of the centroid of site S (such as computed over individual page vectors), and
cos(EV(t), V(S)) Is the cosine between the expanded representation of term t and the site vector that may convey semantic similarity between the feature t and the site s.

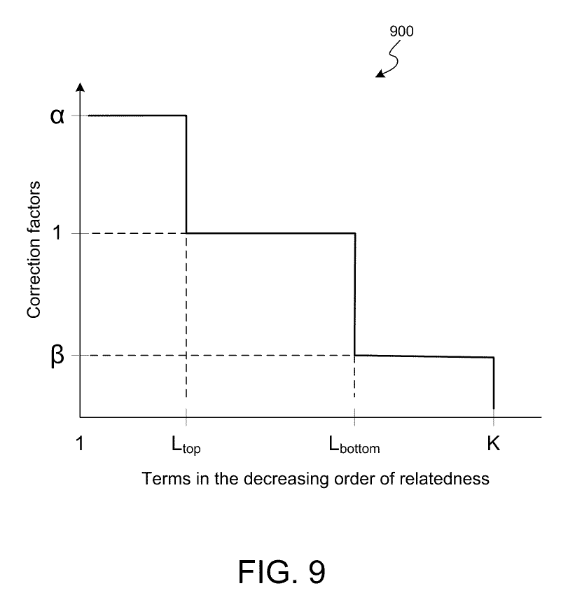

FIG. 9 is a graph 900 illustrating the computation of correction factors using the simplified distance-based example. Once method 100 assesses the relatedness of term t to site S utilizing equation (4), method 100 may arrange all the terms in the decreasing order of their simplified site-level aboutness Ŵ_{simplified}(t, S) scores. Method 100 then may compute the correction factors the top Lₜₒₚ and bottom L_{bottom} terms in the resultant list.

Let Wₜₒₚ^{max} be the relatedness value of the first term in the list, and W_{bottom}^{max} be the relatedness value of the (K−L_{bottom}+1)-th term in the list. In other words, let W_{bottom}^{max} be the first term in the set of the least related terms. For the top terms, the correction factor may be set equal to:

$$α = \frac{{α}_{top}}{{w}_{top}^{max}} . \qquad ( 5 )$$

For the bottom terms, the correction factor may be set equal to:

$$β = \frac{{β}_{bottom}}{{w}_{bottom}^{max}} . \qquad ( 6 )$$

Moreover, for the intermediate terms—those terms that neither are top nor bottom terms, the correction factor may be set equal to:

γ=1 (7).

Method 100 may tune the values of parameters αₜₒₚ and β_{bottom} using a held-out validation set.

### Rank-Based Example

In utilizing the site summary to correct weights given to features in the page summary at processing block 130, the above two examples quantified the relatedness of a term to the site by computing the cosine of the site vector and the term expansion vector. Alternatively, method 100 may employ a rank-based approach to compute site-specific correction factors.

The site centroid vector V(S) is where system 200 arranged the features in the decreasing order of their tf.idf values. Given term t, consider the set of features

F(t, S)=V(S)∩EV(t) (8)

that is common to both V(S) and the expansion vector EV(t) for term t. If the features of F(t, S) rank highly in V(S), then system 200 may identify the term t as likely related closely to the site. On the other hand, if system 200 ranks these features lowly in V(S), or if the intersection F(t, S) is small or empty, then the term likely is to be unrelated to the site. The rank-based example works to capture this.

The maximum size of the term expansion vector M_{w}+Mₚₕ limits the size of F(t, S) in equation (8). In general, the rank-based example may take into account all of the features in the intersection F(t, S). However, experiments have shown that this bring with it a certain amount of noise that prevents system 200 from reliably distinguishing between good and bad terms. By focusing on a subset of P highest ranked features, system 200 may reduce this noise.

In determining the rank-based example, it is important that P be large enough to provide a sufficient number of terms for review. On the other hand, it is important that P be small enough to screen out most of the noise. System 200 utilized a variety of different values of P(1≦P≦M_{w}+Mₚₕ) in experimentation on a held-out validation set. Ultimately, system 200 worked well with P=50 such that the subset may be composed of the fifty highest ranked features.

For each term t, system 200 may compute the average rank AvgRank(t) of the P highest-ranked features of F(t, S) in V(S). If the intersection F(t, S) of equation (8) above has fewer than P features, additional imaginary or marker features may be added to the subset to bring the count up to P features such that the added imaginary features have the maximum possible rank (K). The average rank values are virtually unbounded. Here, only the size K of the vector V(S) limits the average rank values. In other words, system 200 limits the average rank values only by the size K of the number of terms for which system 200 computes the correction factors. Therefore, to compute the final correction factors, system 200 may transform them into the [0, 1] range using the following formula:

$${w}_{rank} ( t , S ) = 1 - \frac{AvgRank ( t )}{K} \qquad ( 9 )$$

where
t Represents a term in website content 310,
S Represents website 330 as the centroid of site S,
Wᵣₐₙₖ(t, S) Is the rank site-level aboutness,
AvgRank(t) Is the average rank of a term t among a set of terms, and
K Is the number of terms utilized to reduce the amount of computation (K=1000, for example).

The connections of network 220 may connect a vast number of websites 330. For example, the February 2007 Netcraft™ Web Server Survey found 108,810,358 distinct websites. In August 2009, that same survey received responses from 225,950,957 distinct websites. Although system 200 may apply site-specific weighting of method 100 to all sites 330, method 100 may be more effective for sites that are topically cohesive.

A website may be topically cohesive if the website primarily is focus on a single topic or a set of closely related topics. For example, the above noted airline photography site may be viewed as being highly cohesive since the site covers the single, very specific topic of airline photography. On the other hand, news sites cover a wide variety of topics, ranging from politics to finance to weather. These sites generally are not topically cohesive.

Site-specific weighting can be highly effective for topically cohesive since the contextual evidence gathered from the site is very strong. However, the contextual signal obtain from site-wide analysis of a news site, for example, may not be as strong as a more cohesive site. Accordingly, method 100 further may be refined by applying a site cohesiveness measure to a given website 300 to determine whether the topically cohesiveness of the site is sufficient to improve online advertisement matching relevance.

The variance of a variable or distribution may be the expected square deviation of that variable from its expected value or mean. System 200 may employ a variance of the term frequency—inverse document frequency values to find a cohesiveness of a given site S. Here, system 200 may determine the cohesiveness of a given site S according to equation (10):

cohesiveness(S)=Var(tf.idf) (10)

where
S Represents website 330 as the centroid of site S, which may include all webpages within a given site or a subset of webpages for that same site,
cohesiveness(S) Is the links or ties that connect text elements to show unity and clarity within or between the subject matters of website 330.
tf.idf Is the raw term frequency—inverse document frequency values in the site centroid vector V(S), and
Var(tf.idf) Is the variance of the raw tf.idf values in the site centroid vector V(S).

Sites that are topically cohesive may have their tf.idf mass centered on a small group of terms. This may result in a small variance. However, sites that are about a wide range of topics may have their tf.idf mass spread across many different terms, resulting in a larger variance.

Site-Specific Weighting Evaluation

To assess method 100, the inventors made several empirical evaluations. For example, the evaluation reviewed the above site-specific term weighting schemes to characterize their effectiveness. In addition, the evaluation characterized the effects of site cohesiveness on site-specific weighting. During the evaluation of method 100, system 200 received two content match data sets from a search engine. Table 2 below presents the summary statistics for CM-A data set and CM-B data set:

TABLE 2

| Name | Pages | Sites | Judgments |
|---|---|---|---|
| CM-A | 650 | 614 | 20,815 |
| CM-B | 342 | 231 | 5,776 |

CM-A data set includes 650 pages from 614 websites. CM-B data set includes 342 pages from 231 websites. The bucket evaluation covered 1,684 sites. For the CM-A and CM-B data sets, human editors judged the quality of ads produced by each algorithm as one of relevant, somewhat relevant, and not relevant. The evaluation collected 20,815 judgments for CM-A data set and 5,775 judgments for CM-B data set.

The evaluation selected the 650 pages of CM-A data set based on the pages having relatively little textual content. Recall that typical content match approaches often perform sub-optimally on the page text is short since even a few topically unrelated words might affect the interpretation of the text. As will be demonstrated below, method 100 may leverage additional contextual information obtained from analyzing the entire website to deemphasize unrelated terms. In turn, this may result in system 200 matching more relevant ads. In other words, method 100 may improve ad matching in data sets such as CM-A data set. In addition, method 100 may work well for large traffic volumes. Thus, the evaluation selected the 342 pages of CM-B data set based on whether they included many ad impressions.

To provide a standard against which the evaluation may measure and compare CM-A data set and CM-B data set, the evaluation utilized a standard bag-of-words-based representation of individual pages with tf.idf weighting. The selected baseline data set did not utilize any site-specific information. For the three data sets, the evaluation utilized graded (i.e., non-binary) relevance judgments. To achieve this, the evaluation measured ad retrieval relevance using metrics based on discounted cumulative gain.

The discounted cumulative gain (DCG) metric is a measure of effectiveness of a Web search engine algorithm or related applications. Using a graded relevance scale of documents in a search engine result set, DCG measures the usefulness, or gain, of a document based on its position in the result list. The evaluation may accumulate the gain cumulatively from the top of a result list to the bottom with the gain of each result discounted at lower ranks DCG may be determined from equation 11:

$$DCG @ K ( Q ) = {\sum }_{i = 1}^{{K}_{max}} \frac{g ( i )}{log ( 1 + i )} \qquad ( 11 )$$

where
Q Is the query correspond to pages on which ads are placed,
K Is the number of terms utilized to reduce the amount of computation (K=1000, for example),
DCG@K(Q) Is the discounted cumulative gain for a given query Q in the set K,
i Is the rank,
Kₘₐₓ Is maximum depth result to consider, and
g(i) Is the gain associated with the rating of result at rank i.

The evaluation utilized gains of 2, 1, and 0, for the relevant, somewhat relevant, and not relevant judgments, respectively. Table 3 below presents the ad retrieval results for the CM-A data set, with the statistically significant improvements (p<0.05) over the baseline bolded:

TABLE 3

| CM-A data set weighting/gains | DCG@1 | DCG@2 | DCG@3 | NDCG |
|---|---|---|---|---|
| Baseline | 0.6692 (—) | 1.0536 (—) | 1.3405 (—) | 0.6024 (—) |
| Distance based example | 0.7077 (+5.8%) | 1.1105 (+5.4%) | 1.4213 (+6.0%) | 0.6485 (+7.6%) |
| Simplified distance based ex. | 0.7134 (+6.7%) | 1.1264 (+6.9%) | 1.4364 (+7.2%) | 0.6511 (+8.1%) |
| Rank based example | N/A | N/A | N/A | N/A |

Due to technical reasons, the evaluation was unable to run the rank-based weighting example on the CM-A data set and thus is not applicable to Table 3 results. Table 4 below presents the ad retrieval results for the CM-B data set, with the statistically significant improvements (p<0.05) over the baseline bolded:

TABLE 4

| CM-B data set weighting/gains | DCG@1 | DCG@2 | DCG@3 | NDCG |
|---|---|---|---|---|
| Baseline | 0.8041 (—) | 1.3059 (—) | 1.6319 (—) | 0.6509 (—) |
| Distance based example | 0.8480 (+5.5%) | 1.3682 (+4.8%) | 1.7264 (+5.8%) | 0.6979 (+7.2%) |
| Simplified distance based ex. | 0.8392 (+4.4%) | 1.3797 (+5.7%) | 1.7467 (+7.0%) | 0.6930 (+6.5%) |
| Rank based example | 0.8450 (+5.1%) | 1.3764 (+5.4%) | 1.7594 (+7.8%) | 0.6874 (+5.6%) |

Table 3 and Table 4 each report DCG@1, DCG@2, and DCG@3 since they may convey ad matching effectiveness. Table 3 also reports the normalized discounted cumulative gain (NDCG) as a normalized version of DCG. An NDCG value of 1 indicates the best possible ranking and NDCG may be computed according to equation (12):

$$\begin{matrix}NDCG ( Q ) = DCG ( Q ) / IDCG ( Q ) \\ = {\sum }_{i = 1}^{N ( Q )} \frac{g ( i )}{log ( 1 + i )} / IDCG ( Q )\end{matrix} \qquad ( 12 )$$

where
N(Q) Is the number of results ranked for query Q; here, the queries correspond to pages on which system 200 places ads,
IDCG(Q) Is the “ideal DCG” achieved if the results for Q were ranked perfectly, and
DCG@K(Q) Is the discounted cumulative gain for a given query Q in the set K.

The DCG and NDCG measures formulated above are query-specific metrics. To report the performance of the algorithms over entire data sets, the evaluation utilized macro-averaging and average the individual DCG/NDCG values over all the pages. Each statistical significance test made use of a one-tailed paired t-test at the p<0:05 level.

The evaluation tuned all of the free parameters the weighting schemes on a held-out validation data set. The held-out validation data set had zero intersection with the evaluated CM-A data set and the CM-B data sets. The tuning done was not exhaustive, as the overall parameter space is rather large and complex. Therefore, it is likely that the evaluation could improve on the results reported in Table 3 and Table 4 with more fine-tuning

The CM-A data set results of Table 3 demonstrate that both the distance-based and simplified distance-based weighting schemes result in statistically significant improvements over the baseline. The distance-based and simplified distance-based weighting schemes are statistically equivalent across all metrics. However, the simplified distance-based method does tend to perform better across all measures. The improvements achieved on this data set are rather substantial, with method 100 improving NDCG by 8.1% over the baseline.

The CM-B data set results of Table 4 are quite similar to the CM-A results of Table 4. Recall that the CM-A data set represented pages having relatively little textual content and the CM-B data set represented large traffic volume pages—those having many ad impressions. Since the CM-B data set results of Table 4 are quite similar to the CM-A results of Table 4, method 100 is not only applicable to pages with little content, but also to more popular, high traffic pages, as well.

Importantly, all of the site-specific weighting examples achieve statistically significant improvements over the baseline. Although the distance-based weighting results in the largest NDCG improvement (+7.2%), the rank-based example consistently yields statistically significant improvements across all the metrics. In short, the results of Table 3 and Table 4 demonstrate that site-specific weighting consistently and significantly improves ad-matching quality for content match. Significantly, the evaluation found that each weighting method produce significantly improved results. Accordingly, each method would improve content match effectiveness, not only for pages with little content, but also for content-rich pages, as well.

Evaluation of Site Cohesiveness and Site-Specific Weighting

To refine method 100 further, system 200 may utilize site cohesiveness on ad matching using site-specific weighting. In this regard, site-specific weighting may be more effective for topically cohesive sites than topically diverse sites. The following experiment shows this.

In the experiment conducted, the evaluation compiled a data set of sites, where each site had a level of topic cohesiveness that may have varied from one site to another. Then, the evaluation computed the cohesiveness measure for every site in the set to divide them into cohesive and noncohesive groups based on their cohesiveness. The evaluation performed the split by assigning all sites with cohesiveness measure less than some threshold to the cohesive group and the rest of the sites to the non-cohesive group. For every possible threshold setting, the evaluation computed two numbers: (i) the percentage of sites considered cohesive for that threshold (the coverage) and, (ii) the relative NDCG improvement of the sites in the cohesive group when site-specific weighting is used.

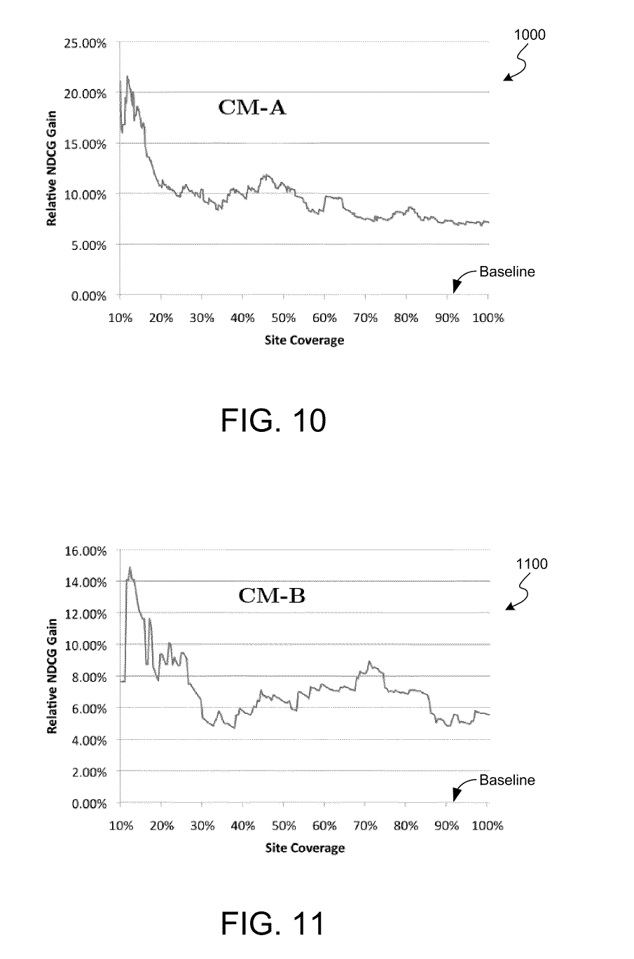

FIG. 10 is a plot of the NDCG gain for the CM-A data set over the baseline. FIG. 11 is a plot of the NDCG gain for the CM-B data set over the baseline. As noted above, the CM-A data set represented pages having relatively little textual content and the CM-B data set represented large traffic volume pages—those having many ad impressions.

In regards to pages having relatively little textual content (the CM-A data set) and large traffic volume pages (the CM-B data set), the plots illustrate that when the evaluation applied the site-specific weighting of method 100 to very cohesive sites, the application achieved very large gains in NDCG for the affected sites. For example, for the CM-A data set of FIG. 10, the evaluation achieve approximately a 10% relative NDCG gain when the threshold is set to cover 50% of the sites. Similar results hold for the CM-B data set of FIG. 11, although the curve did not behave as well as the CM-A data set curve primarily due to the CM-B data set being smaller than the CM-A data set. In sum, method 100 improves effectiveness for less cohesive sites having more advertising opportunities and improves effectiveness for more cohesive sites having a greater likelihood of advertising click through.

### Illustrative Examples

To convey method 100 further, system 200 utilized method 100 on real-life webpages to generate illustrative examples of how method 100 may affect ad ranking, both for the positive and for the negative. The evaluation selected three webpages from three different websites and ran a baseline method and method 100 on each of the three webpages to receive output advertisements. The evaluation sought to compare method 100 to the baseline method to in regards to advertisements that were more contextually relevant to the webpage than not.

For the first webpage, the evaluation utilized a forum page on a site devoted to hockey fights. The particular forum page contained little meaningful content, which is more in line with the CM-A data set. However, the forum allows users to vote in favor of (“thumbs up”) or against (“thumbs down”) each forum posting. Table 5 below presents the top three advertisements output from the baseline method (left) and the site-specific weighting system of method 100 (right):

TABLE 5
Webpage: http://www.hockeyfights.com/forums/ . . .

| | Contextually | Site-specific weighting system output | Contextually |
|---|---|---|---|
| Baseline output advertisements | relevant? | advertisements | relevant? |
| Hockey Fights | Yes | Hockey Fights | Yes |
| Browse a huge selection now. Find | | Browse a huge selection now. Find | |
| exactly what you want today. | | exactly what you want today. | |
| www.EBAY.com | | www.EBAY.com | |
| Thumb TV | No | Hockey Fight DVDs | Yes |
| Thumb TV & More. 100,000 Stores. | | Browse a huge selection now. Find | |
| Deals. Reviews. | | exactly what want today. | |
| shopping.YAHOO.com | | www.EBAY.com | |
| Thumb Brace/Thumb Spica | No | Hockey Equipment | Yes |
| ALIMED - Industry Leader in | | Free shipping on $149.00+. Save up to | |
| Affordable Thumb Brace Products. | | 70% on Hockey Equipment. | |
| www.ALIMED.com | | www.HOCKEYMONKEY.com | |

The evaluation slightly modified the syntax of the original output advertisements to satisfy the space constraints of the Table 5. As presented in Table 5, the baseline system identified the term “thumb” as an important term on the page, because it occurred many times and, in general, is relatively rare (i.e., has high IDF inverse document frequency). In comparison, the site-specific weighting of method 100 significantly downweighted the term “thumb” because method 100 determined that thumb and its variations such as “thumbs up” and “thumbs down” were not relevant to the hockey fight site. In addition, method 100 upweighted the term “hockey” and “hockey fight” resulting in more contextually relevant ads than for the baseline system.

For the second webpage, the evaluation utilized a webpage on a site devoted an online game called Bunny Bounty™. In Bunny Bounty™, the player pest exterminator utilizes various weapons to scare off, deter, neutralize, and otherwise prevent bunnies from looting and plundering yields from a farm crop. The pest exterminator starts with a slingshot and gains access to improved anti-bunny weaponry as his/her exterminating success increases. Table 6 below presents the top three advertisements output from the baseline method (left) and the site-specific weighting system of method 100 (right):

TABLE 6
Webpage: http://www.BUBBLEBOX.com/game/action/ . . .

| | Contextually | Site-specific weighting system output | Contextually |
|---|---|---|---|
| Baseline output advertisements | relevant? | advertisements | relevant? |
| Bunnies | No | Online Games | Yes |
| Browse a huge selection now. Find | | Browse a huge selection now. Find | |
| exactly what you want today. | | exactly what you want today. | |
| www.EBAY.com | | www.EBAY.com | |
| Bunnies By The Bay | No | Play Free Online Games | Yes |
| Browse a huge selection now. Find | | Have fun & test your game skills online | |
| exactly what you want today. | | www.WORLDWINNER.com | |
| www.EBAY.com | | | |
| Monogrammed Bunny | No | Play Games at FREEARCADE.com | Yes |
| Monogram a child's name on the ear | | Free online puzzle Games. Play against | |
| of this soft, plush bunny. | | the computer! | |
| www.FANCYSTICHESONLINE.com | | www.freearcade.com | |

The evaluation slightly modified the syntax of the original output advertisements to satisfy the space constraints of the Table 6. As presented in Table 6, the baseline system overweighted “bunny,” because of its high term frequency on the page and high IDF. The site-specific weighting properly upweighted terms related to online games, since the site the page occurs on, www.bubblebox.com, is primarily about games. Like the first example, this second example also illustrates how site-specific weighting can help improve ad matching.

For the third webpage, the evaluation utilized the download page for encryption software on a computer-related site. Although the site generally is about computers, it is in no way cohesive, since it covers a diverse range of topics. Table 7 below presents the top three advertisements output from the baseline method (left) and the site-specific weighting system of method 100 (right):

TABLE 7
Webpage: http://MAJORGEEKS.com/TrueCrypt . . .

| | Contextually | Site-specific weighting system output | Contextually |
|---|---|---|---|
| Baseline output advertisements | relevant? | advertisements | relevant? |
| Encryption Software | Yes | Windows Vista Deals | Yes |
| Download free software to encrypt | | Upgrade to Windows Vista for Less. Get | |
| files and emails under Windows. | | the Newest OS. | |
| www.NCHSOFTWARE.com/encrypt | | www.NEXTAG.com | |
| File and Disk Encryption | Yes | Free spyware remove download.com | No |
| Looking to Prevent Data Theft? | | Scan, Block and Remove all Adware - | |
| Ceelox, Precise, Seagate & More. | | 100% Guaranteed. | |
| www.ENVOYDATA.com | | www.ADWARE-download.com | |
| PGP Hard Disk Encryption | Yes | TurboTax - Free Filing | No |
| Great Enterprise Solution. Free | | File Simple Taxes Free with New Fed | |
| Buyer's Guide. | | Free Edition. | |
| PGP.com | | www.TURBOTAX.com | |

The evaluation slightly modified the syntax of the original output advertisements to satisfy the space constraints of the Table 7. Table 7 presents a case where site-specific weighting can bring back less favorable results, such as when a topically diverse website hosts the target webpage. Here, the baseline system properly shows ads that are specifically relevant to the webpage. However, the site-specific weighting matches very generic ads that are much less relevant to the page, although are still relevant to the site. Considering less than all webpages on the MAJORGEEKS.com website as the website utilized in method 100 may improve the site-specific weighting. In addition, a best matching strategy should consider many factors, including site cohesiveness, page specificity, and the commercialness of the page.

The above description presented a method to improve contextual advertising using site-level textual analysis. The method computes site-level correction factors in which the system may use to modify page-level weights. In the three approaches to estimate the correction factors, each approach made use of the semantic similarity of features to the entire site. Experimental results showed that each method consistently and significantly improved ad matching effectiveness across two real-world data sets collected from a large commercial search engine. Moreover, the system may utilize site-level correction factors with greater success for topically cohesive sites and pages that have very little textual content.

In addition to the above site-level analysis, the methods may consider the actual advertisement that the site is to receive. In addition, some of the features upweighted by the system may never actually match to any ads. Therefore, it may be useful to tie the correction factors to the ad inventory, such as by passing the ad inventor terms through method 100 as a webpage relative to the target webpage and the hosting website.

The system may learn correction factors automatically through click data resulting from the depression of a button on a computer mouse to select an advertisement or term on the webpage. For example, a page feature vector f(P) and an ad feature vector f(A) may be utilized as part of a site-adjusted information retrieval (IR) score S(P, A), where S(P, A)=f(P)·diag(Λ)·f(A). Here, system 200 may learn the site-specific feature weight-adjustment vector Λ from clicks or editorial data. This may be possible for sites with many ad impressions. For sites that do not have enough traffic to estimate corrections accurately, the system may utilize the above unsupervised-approaches.

System 200 may apply method 100 to improve web search ranking since contextual information may be useful to rank web searches. Here, site-level weighting, similar in spirit to the approach described above, may improve web search effectiveness.

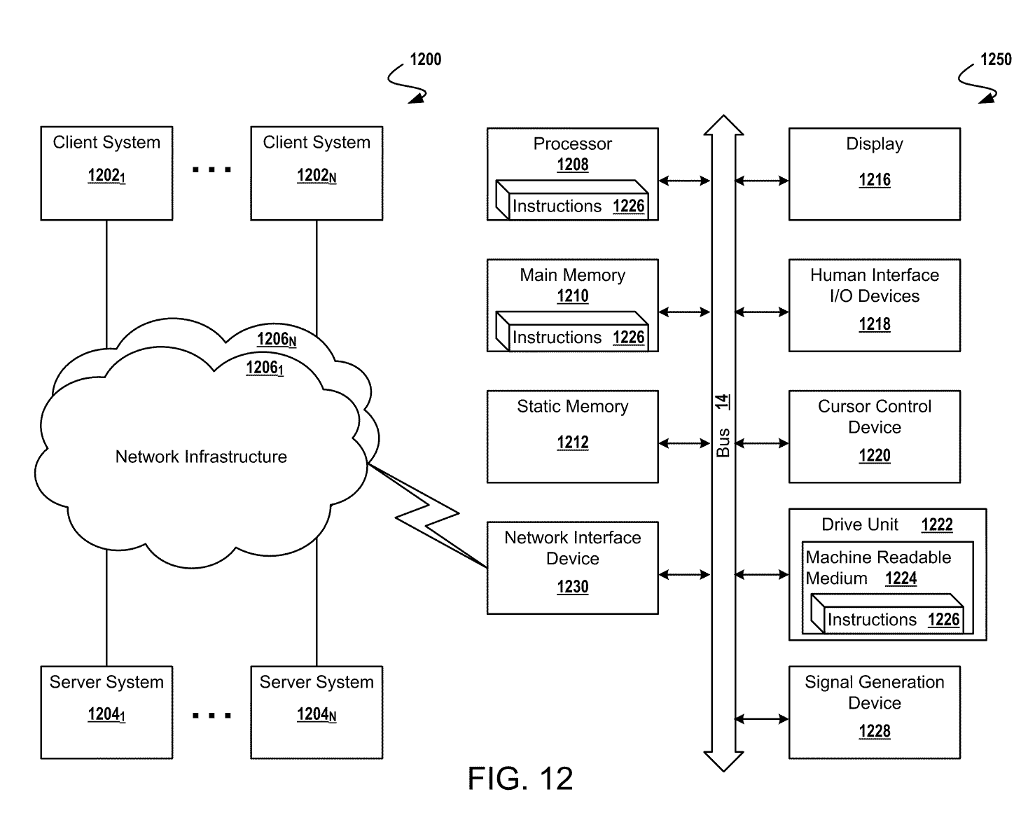

FIG. 12 is a diagrammatic representation of a network 1200, including nodes for client computer systems 1202₁ through 1202_{N}, nodes for server computer systems 1204₁ through 1204_{N}, nodes for network infrastructure 1206₁ through 1206_{N}, any of which nodes may comprise a machine 1250 within which a set of instructions for causing the machine to perform any one of the techniques discussed above may be executed. The embodiment shown is purely exemplary, and might be implemented in the context of one or more of the figures herein.

Any node of the network 1200 may comprise a general-purpose processor, a digital signal processor (DSP), an application specific integrated circuit (ASIC), a field programmable gate array (FPGA) or other programmable logic device, discrete gate or transistor logic, discrete hardware components, or any combination thereof capable to perform the functions described herein. A general-purpose processor may be a microprocessor, but in the alternative, the processor may be any conventional processor, controller, microcontroller, or state machine. A system also may implement a processor as a combination of computing devices (e.g., a combination of a DSP and a microprocessor, a plurality of microprocessors, one or more microprocessors in conjunction with a DSP core, or any other such configuration, etc).

In alternative embodiments, a node may comprise a machine in the form of a virtual machine (VM), a virtual server, a virtual client, a virtual desktop, a virtual volume, a network router, a network switch, a network bridge, a personal digital assistant (PDA), a cellular telephone, a web appliance, or any machine capable of executing a sequence of instructions that specify actions to be taken by that machine. Any node of the network may communicate cooperatively with another node on the network. In some embodiments, any node of the network may communicate cooperatively with every other node of the network. Further, any node or group of nodes on the network may comprise one or more computer systems (e.g., a client computer system, a server computer system) and/or may comprise one or more embedded computer systems, a massively parallel computer system, and/or a cloud computer system.

The computer system 1250 includes a processor 1208 (e.g., a processor core, a microprocessor, a computing device, etc), a main memory 1210 and a static memory 1212, which communicate with each other via a bus 1214. The machine 1250 may further include a display unit 1216 that may comprise a touch-screen, or a liquid crystal display (LCD), or a light emitting diode (LED) display, or a cathode ray tube (CRT). As shown, the computer system 1250 also includes a human input/output (I/O) device 1218 (e.g., a keyboard, an alphanumeric keypad, etc), a pointing device 1220 (e.g., a mouse, a touch screen, etc), a drive unit 1222 (e.g., a disk drive unit, a CD/DVD drive, a tangible computer readable removable media drive, an SSD storage device, etc), a signal generation device 1228 (e.g., a speaker, an audio output, etc), and a network interface device 1230 (e.g., an Ethernet interface, a wired network interface, a wireless network interface, a propagated signal interface, etc).

The drive unit 1222 includes a machine-readable medium 1224 on which is stored a set of instructions (i.e., software, firmware, middleware, etc) 1226 embodying any one, or all, of the methodologies described above. The set of instructions 1226 also may reside, completely or at least partially, within the main memory 1210 and/or within the processor 1208. The network bus 1214 of the network interface device 1230 may provide a way to further transmit or receive the set of instructions 1226.

A computer may include a machine to perform calculations automatically. A computer may include a machine that manipulates data according to a set of instructions. In addition, a computer may include a programmable device that performs mathematical calculations and logical operations, especially one that can process, store and retrieve large amounts of data very quickly.

It is to be understood that embodiments of this invention may be used as, or to support, a set of instructions executed upon some form of processing core (such as the CPU of a computer) or otherwise implemented or realized upon or within a machine- or computer-readable medium. A machine-readable medium includes any mechanism for storing or transmitting information in a form readable by a machine (e.g., a computer). For example, a machine-readable medium includes read-only memory (ROM); random access memory (RAM); magnetic disk storage media; optical storage media; flash memory devices; electrical, optical, acoustical, or any other type of media suitable for storing information.

A computer program product on a storage medium having instructions stored thereon/in may implement part or all of system 200. The system may use these instructions to control, or cause, a computer to perform any of the processes. The storage medium may include without limitation any type of disk including floppy disks, mini disks (MD's), optical disks, DVDs, CD-ROMs, micro-drives, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any type of media or device suitable for storing instructions and/or data.

Storing may involve putting or retaining data in a memory unit such as a storage medium. Retrieving may involve locating and reading data from storage. Delivering may involve carrying and turning over to the intended recipient. For example, information may be stored by putting data representing the information in a memory unit, for example. The system may store information by retaining data representing the information in a memory unit, for example. The system may retrieve the information and deliver the information downstream for processing. The system may retrieve a message such as an advertisement from an advertising exchange system, carried over a network, and turned over to a member of a target-group of members.

Stored on any one of the computer readable medium, system 200 may include software both to control the hardware of a general purpose/specialized computer or microprocessor and to enable the computer or microprocessor to interact with a human consumer or other mechanism utilizing the results of system 200. Such software may include without limitation device drivers, operating systems, and user applications. Ultimately, such computer readable medium further may include software to perform system 200.

Although the system may utilize the techniques in the online advertising context, the techniques also may be applicable in any number of different open exchanges where the open exchange offers products, commodities, or services for purchase or sale. Further, many of the features described herein may help data buyers and others to target users in audience segments more effectively. However, while data in the form of segment identifiers may be generally stored and/or retrieved, examples of the invention preferably do not require any specific personal identifier information (e.g., name or social security number) to operate.

The techniques described herein may be implemented in digital electronic circuitry, or in computer hardware, firmware, software recorded on a computer-readable medium, or in combinations of them. The system may implement the techniques as a computer program product, i.e., a computer program tangibly embodied in an information carrier, including a machine-readable storage device, for execution by, or to control the operation of, data processing apparatus, e.g., a programmable processor, a computer, or multiple computers. Any form of programming language may convey a written computer program, including compiled or interpreted languages. A system may deploy the computer program in any form, including as a stand-alone program or as a module, component, subroutine, or other unit recorded on a computer-readable medium and otherwise suitable for use in a computing environment. A system may deploy a computer program for execution on one computer or on multiple computers at one site or distributed across multiple sites and interconnected by a communication network.

A system may perform the methods described herein in programmable processors executing a computer program to perform functions disclosed herein by operating on input data and generating output. A system also may perform the methods by special purpose logic circuitry and implement apparatus as special purpose logic circuitry special purpose logic circuitry, e.g., an FPGA (field programmable gate array) or an ASIC (application-specific integrated circuit). Modules may refer to portions of the computer program and/or the processor/special circuitry that implements that functionality. An engine may be a continuation-based construct that may provide timed preemption through a clock that may measure real time or time simulated through language like scheme. Engines may refer to portions of the computer program and/or the processor/special circuitry that implements the functionality. A system may record modules, engines, and other purported software elements on a computer-readable medium. For example, a processing engine, a storing engine, a retrieving engine, and a delivering engine each may implement the functionality of its name and may be recorded on a computer-readable medium.

Processors suitable for the execution of a computer program include, by way of example, both general and special purpose microprocessors, and any processors of any kind of digital computer. Generally, a processor may receive instructions and data from a read-only memory or a random access memory or both. Essential elements of a computer may be a processor for executing instructions and memory devices for storing instructions and data. Generally, a computer also includes, or may be operatively coupled to receive data from or transfer data to, or both, mass storage devices for storing data, e.g., magnetic, magneto-optical disks, or optical disks. Information carriers suitable for embodying computer program instructions and data include all forms of non-volatile memory, including by way of example semiconductor memory-devices, e.g., EPROM, EEPROM, and flash memory devices; magnetic disks, e.g., internal hard disks or removable disks; magneto-optical disks; and CD-ROM and DVD-ROM disks. A system may supplement a processor and the memory by special purpose logic circuitry and may incorporate the processor and the memory in special purpose logic circuitry.

To provide for interaction with a user, the techniques described herein may be implemented on a computer having a display device, e.g., a CRT (cathode ray tube) or LCD (liquid crystal display) monitor, for displaying information to the user and a keyboard and a pointing device, e.g., a mouse or a trackball, by which the user provides input to the computer (e.g., interact with a user interface element, for example, by clicking a button on such a pointing device). Other kinds of devices may be used to provide for interaction with a user as well; for example, feedback provided to the user includes any form of sensory feedback, e.g., visual feedback, auditory feedback, or tactile feedback; and input from the user may be received in any form, including acoustic, speech, or tactile input.

The techniques described herein may be implemented in a distributed computing system that includes a back-end component, e.g., as a data server, and/or a middleware component, e.g., an application server, and/or a front-end component, e.g., a client computer having a graphical user interface and/or a Web browser through which a user interacts with an implementation of the invention, or any combination of such back-end, middleware, or front-end components. A system may interconnect the components of the system by any form or medium of digital data communication, e.g., a communication network. Examples of communication networks include a local area network (“LAN”) and a wide area network (“WAN”), e.g., the Internet, and include both wired and wireless networks.

The computing system may include clients and servers. A client and server may be generally remote from each other and typically interact over a communication network. The relationship of client and server arises by virtue of computer programs running on the respective computers and having a client-server relationship to each other. One of ordinary skill recognizes any or all of the foregoing implemented and described as computer readable media.

In the above description, numerous details have been set forth for purpose of explanation. However, one of ordinary skill in the art will realize that a skilled person may practice the invention without the use of these specific details. In other instances, the disclosure may present well-known structures and devices in block diagram form to avoid obscuring the description with unnecessary detail. In other words, the details provide the information disclosed herein merely to illustrate principles. A skilled person should not construe this as limiting the scope of the subject matter of the terms of the claims. On the other hand, a skilled person should not read the claims so broadly as to include statutory and nonstatutory subject matter since such a construction is not reasonable. Here, it would be unreasonable for a skilled person to give a scope to the claim that is so broad that it makes the claim non-statutory. Accordingly, a skilled person is to regard the written specification and figures in an illustrative rather than a restrictive sense. Moreover, a skilled person may apply the principles disclosed to achieve the advantages described herein and to achieve other advantages or to satisfy other objectives, as well.

What is claimed is:

1. A contextual advertising method implemented in a computer to select online advertisements for display on a network location, the method comprising:
receiving, at a computer, page content of a page and site content of a site, wherein the site includes the page;
processing, in the computer, the page content and site content by:
transforming the page content into a textual representation;
transforming the site content into a site signature;
modifying the textual representation utilizing the site signature to produce a modified textual representation; and
utilizing the modified textual representation to select an online advertisement.

2. The method of claim 1, where the textual representation includes weighted page term vectors and where the modified textual representation includes modified page term vectors.

3. The method of claim 2, further comprising:
computing the site signature for a page term in the site by determining how semantically related the page term is to the site and by determining how prominent the page term is to the site.

4. The method of claim 3, further comprising:
computing the site signature for a page term t in the site S according to the equation:
Ŵ(t, S)=cos(EV(t), V(S))·tf(t, S)·sidf(t, S),
wherein, the site signature Ŵ(t, S) is the site-level aboutness, cos(EV(t), V(S)) is the cosine between the expanded representation of term t and the site vector, tf(t, S) is the term frequency as a function of the number of times that term t occurs within the site S, and sidf(t, S) is the site-level inverse document frequency of the term t.

5. The method of claim 4, further comprising:
applying a correction factor the site signature Ŵ(t, S) according to the equation
$$w ( t , S ) = \frac{\hat{w} ( t , S )}{\frac{1}{\vert T ( S ) \vert} {\sum }_{t ∈ T ( S )}^{ } \hat{w} ( t , S )} ,$$
wherein, w(t, S) is the scaled site-level aboutness and T(S) is the set of terms for which the correction factors are computed on site S.

6. The method of claim 2, further comprising:
computing the site signature for a page term in the site by determining how semantically related the page term is to the site.

7. The method of claim 6, further comprising:
computing the site signature for a page term t in the site S according to the equation
Ŵ_{simplified}(t, S)=cos(EV(t), V(S)),
wherein, the site signature Ŵ_{simplified}(t, S) is the site-level aboutness and cos(EV(t), V(S)) is the cosine between the expanded representation of term t and the site vector.

8. The method of claim 2, further comprising:
computing the site signature for a page term in the site by computing the average rank of a set of highest-ranked terms.

9. The method of claim 8, further comprising:
computing the site signature for a page term t in the site S according to the equation
$${w}_{rank} ( t , S ) = 1 - \frac{AvgRank ( t )}{K} ,$$
wherein, the site signature Wᵣₐₙₖ(t, S) is the rank site-level aboutness, AvgRank(t) is the average rank of a term t among a set of terms, and K is the number of terms utilized to reduce the amount of computation.

10. The method of claim 2, further comprising:
determining the cohesiveness of the site.

11. The method of claim 10, where determining the cohesiveness of the site S is according to the equation
cohesiveness (S)=Var(tf.idf)
wherein Var(tf.idf) is the variance of the raw term frequency—inverse document frequency tf.idf values in the site S; and
computing the site signature for a page term t in the site S only if the cohesiveness of the site S is less than a predetermined cohesiveness threshold.

12. A computer readable medium containing executable instructions stored thereon, which, when executed in a computer, cause the computer to select online advertisements for display on a network location, the instructions for:
receiving, at a computer, page content of a page and site content of a site, wherein the site includes the page;
processing, in the computer, the page content and site content by:
transforming the page content into a textual representation;
transforming the site content into a site signature;
modifying the textual representation utilizing the site signature to produce a modified textual representation; and
utilizing the modified textual representation to select an online advertisement.

13. The computer readable medium of claim 12, where the textual representation includes weighted page term vectors and where the modified textual representation includes modified page term vectors.

14. The computer readable medium of claim 13, further comprising:
computing the site signature for a page term in the site by determining how semantically related the page term is to the site and by determining how prominent the page term is to the site.

15. The computer readable medium of claim 14, further comprising:
computing the site signature for a page term t in the site S according to the equation:
ŴW(t, S)=cos(EV(t), V(S))·tf(t, S)·sidf(t, S),
wherein, the site signature Ŵ(t, S) is the site-level aboutness, cos(EV(t), V(S)) is the cosine between the expanded representation of term t and the site vector, tf(t, S) is the term frequency as a function of the number of times that term t occurs within the site S, and sidf(t, S) is the site-level inverse document frequency of the term t.

16. The computer readable medium of claim 15, further comprising:
applying a correction factor the site signature Ŵ(t, S) according to the equation
$$w ( t , S ) = \frac{\hat{w} ( t , S )}{\frac{1}{\vert T ( S ) \vert} {\sum }_{t ∈ T ( S )}^{ } \hat{w} ( t , S )} ,$$
wherein, w(t, S) is the scaled site-level aboutness and T(S) is the set of terms for which the correction factors are computed on site S.

17. The computer readable medium of claim 12, further comprising:
computing the site signature for a page term in the site by determining how semantically related the page term is to the site.

18. The computer readable medium of claim 17, further comprising:
computing the site signature for a page term t in the site S according to the equation
Ŵ_{simplified}(t, S)=cos(EV(t), V(S)),
wherein, the site signature Ŵ_{simplified}(t, S) is the site-level aboutness and cos(EV(t), V(S)) is the cosine between the expanded representation of term t and the site vector.

19. The computer readable medium of claim 12, further comprising:
computing the site signature for a page term in the site by computing the average rank of a set of highest-ranked terms.

20. The computer readable medium of claim 19, further comprising:
computing the site signature for a page term t in the site S according to the equation
$${w}_{rank} ( t , S ) = 1 - \frac{AvgRank ( t )}{K} ,$$
wherein, the site signature Wᵣₐₙₖ(t, S) is the rank site-level aboutness, AvgRank(t) is the average rank of a term t among a set of terms, and K is the number of terms utilized to reduce the amount of computation.

21. The computer readable medium of claim 12, further comprising:
determining the cohesiveness of the site.

22. The computer readable medium of claim 21, where determining the cohesiveness of the site S is according to the equation
cohesiveness(S)=Var(tf.idf)
wherein Var(tf.idf) is the variance of the raw term frequency—inverse document frequency tf.idf values in the site S; and
computing the site signature for a page term t in the site S only if the cohesiveness of the site S is less than a predetermined cohesiveness threshold.

23. A system to select online advertisements for display on a network location, the system comprising:
at least one web server, comprising at least one processor and memory, to receive page content of a page and to receive site content of a site over a network, wherein the site includes the page; and
a processing and matching platform, comprising at least one processor and memory, coupled to the web server to transform page content of the page into textual representation, to transform site content of the site into a site signature, to correct the textual representation utilizing the site signature to produce modified page term vectors, and to select an online advertisement utilizing the modified page term vectors.

24. The system of claim 23, where the textual representation includes weighted page term vectors and where the modified textual representation includes modified page term vectors.

25. The system of claim 24, the processing and matching platform further for computing the site signature for a page term in the site by determining how semantically related the page term is to the site and by determining how prominent the page term is to the site.

26. The system of claim 25, the processing and matching platform further for computing the site signature for a page term t in the site S according to the equation:
Ŵ(t, S)=cos(EV(t), V(S))·tf(t, S)·sidf(t, S),
wherein, the site signature Ŵ(t, S) is the site-level aboutness, cos(EV(t), V(S)) is the cosine between the expanded representation of term t and the site vector, tf(t, S) is the term frequency as a function of the number of times that term t occurs within the site S, and sidf(t, S) is the site-level inverse document frequency of the term t.

27. The system of claim 26, the processing and matching platform further for applying a correction factor the site signature Ŵ(t, S) according to the equation
$$w ( t , S ) = \frac{\hat{w} ( t , S )}{\frac{1}{\vert T ( S ) \vert} {\sum }_{t ∈ T ( S )}^{ } \hat{w} ( t , S )} ,$$
wherein, w(t, S) is the scaled site-level aboutness and T(S) is the set of terms for which the correction factors are computed on site S.

28. The system of claim 24, further comprising:
computing the site signature for a page term in the site by determining how semantically related the page term is to the site.

29. The system of claim 28, the processing and matching platform further for computing the site signature for a page term t in the site S according to the equation
Ŵ_{simplified}(t, S)=cos(EV(t), V(S)),
wherein, the site signature Ŵ_{simplified}(t, S) is the site-level aboutness and cos(EV(t), V(S)) is the cosine between the expanded representation of term t and the site vector.

30. The system of claim 24, the processing and matching platform further for computing the site signature for a page term in the site by computing the average rank of a set of highest-ranked terms.

31. The system of claim 30, the processing and matching platform further for computing the site signature for a page term t in the site S according to the equation
$${w}_{rank} ( t , S ) = 1 - \frac{AvgRank ( t )}{K} ,$$
wherein, the site signature Wᵣₐₙₖ(t, S) is the rank site-level aboutness, AvgRank(t) is the average rank of a term t among a set of terms, and K is the number of terms utilized to reduce the amount of computation.

32. The system of claim 24, the processing and matching platform further for determining the cohesiveness of the site.

33. The system of claim 32, where determining the cohesiveness of the site S is according to the equation
cohesiveness(S)=Var(tf.idf)
wherein Var(tf.idf) is the variance of the raw term frequency—inverse document frequency tf.idf values in the site S; and
computing the site signature for a page term t in the site S only if the cohesiveness of the site S is less than a predetermined cohesiveness threshold.
